(19) United States
(12) Patent Application Publication
(10) Pub. No.: US 2026/0025688 A1
(43) Pub. Date: Jan. 22, 2026

(54) CHANNEL STATE INFORMATION OMISSIONS FROM CHANNEL STATE INFORMATION REPORTS

(71) Applicant: Google LLC, Mountain View, CA (US)

(72) Inventors: Yushu Zhang, Beijing (CN); Chih-Hsiang Wu, Taipei City (TW)

(21) Appl. No.: 18/994,549

(22) PCT Filed: May 25, 2023
(86) PCT No.: PCT/CN2023/096255

§ 371 Date: Jan. 14, 2025

(30) Foreign Application Priority Data
Aug. 12, 2022 (WO) PCT/CN2022/112193

(51) Int. Cl. H04W 24/10; H04W 28/06

(52) U.S. Cl. CPC H04W 24/10; H04W 28/06

(57) ABSTRACT

Various aspects of the present disclosure generally relate to wireless communication. In some aspects, a first device may generate a multi-part neural network based channel state information feedback (CSF) message that comprises: a first part that indicates contents of a second part, and the second part; and transmit the multi-part neural network based CSF to a second device. Numerous other aspects are provided.

### CROSS REFERENCE TO RELATED APPLICATION(S)

This application claims the benefit of and priority to International Application No. PCT/CN2022/112193, entitled “CSI Reports based on ML Techniques” and filed on Aug. 12, 2022, which is expressly incorporated by reference herein in its entirety.

### TECHNICAL FIELD

The present disclosure relates generally to wireless communication, and more particularly, to channel state information (CSI) omissions from CSI reports.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, UEs and base stations can support more antenna configurations and multi-connectivity. One consequence, however, is that channel state information (CSI) reports have become larger and more complex.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A user equipment (UE) may receive one or more channel state information-reference signals (CSI-RSs) from a network entity, such as a base station, for estimating a channel based on CSI measurement(s) of the one or more CSI-RSs. The UE uses the CSI measurements to generate channel state information (CSI) reports. In examples, the UE generates at least one of the CSI reports based on a machine learning (ML) model. However, complexities associated with ML-based CSI reports and/or complexities associated with transmission of multiple CSI reports (e.g., multiple non-ML-based CSI reports or combinations of ML-based/non-ML-based CSI reports) may cause a total payload size of a CSI report transmission to the network entity to exceed a threshold For instance, the transmission may exceed a maximum payload size for physical uplink shared channel (PUSCH) or physical uplink control channel (PUCCH) resources configured for CSI reporting.

Aspects of the present disclosure address the above-noted and other deficiencies by configuring the UE to omit a portion of, or all of, a CSI report from the CSI report transmission to reduce the total payload to a size that is less than or equal to the maximum payload size for the PUSCH/PUCCH resources. That is, the UE may either replace complex ML-based CSI reports with less complex, non-ML-based CSI reports to reduce overhead associated with the CSI report transmission or truncate the ML-based/non-ML-based CSI reports included in the CSI report transmission to smaller payload size.

According to some aspects, the UE receives, from a network entity, a CSI-RS associated with a first CSI report. The UE transmits, to the network entity, a CSI report transmission with at least a first portion of the first CSI report being omitted from the CSI report transmission when a total payload size of the CSI report transmission exceeds a threshold.

According to some aspects, the network entity transmits, to the UE, the CSI-RS associated with the first CSI report. The network entity receives, from the UE, the CSI report transmission with the at least the first portion of the first CSI report being omitted from the CSI report transmission based on the total payload size of the CSI report transmission exceeding the threshold.

### BRIEF DESCRIPTION OF THE DRAWINGS

FIG. 1 illustrates a diagram of a wireless communications system including a plurality of user equipments (UEs) and network entities in communication over one or more cells.

FIG. 2 illustrates a diagram for example machine learning (ML)-based channel state information (CSI) encoder compression at a UE and example ML-based CSI decoder decompression at a network entity.

FIG. 3A illustrates a signaling diagram of a first CSI reporting procedure associated with CSI omission techniques.

FIG. 3B illustrates a signaling diagram of a second CSI reporting procedure associated with the CSI omission techniques.

FIG. 4 is a flowchart of a method of wireless communication at a UE for reporting ML-based/non-ML-based CSI reports based on the CSI omission procedure of FIG. 3A.

FIG. 5 is a flowchart of a method of wireless communication at a network entity for reporting the ML-based/non-ML-based CSI reports based on the CSI omission procedure of FIG. 3A.

FIG. 6 is a flowchart of a method of wireless communication at a UE for reporting ML-based/non-ML-based CSI reports based on the CSI omission procedure of FIG. 3B.

FIG. 7 is a flowchart of a method of wireless communication at a network entity for reporting the ML-based/non-ML-based CSI reports based on the CSI omission procedure of FIG. 3B.

FIGS. 8A-8C illustrate tables for ML-based CSI reports.

FIG. 9 is a diagram illustrating an example of a hardware implementation for an example UE apparatus.

FIG. 10 is a diagram illustrating an example of a hardware implementation for one or more example network entities.

### DETAILED DESCRIPTION

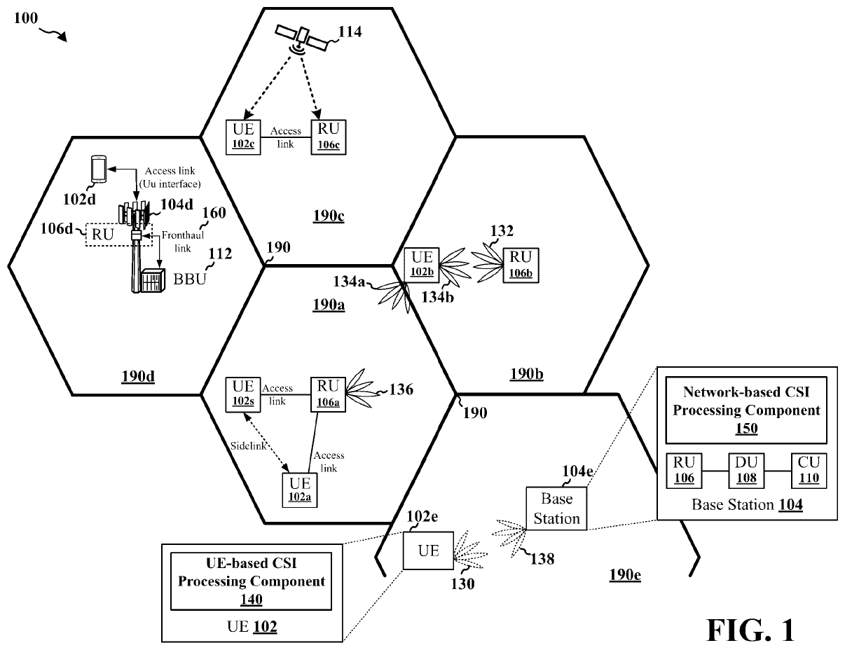

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108 and the CU 110. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHZ-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHZ, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 may or may not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a UE-based channel state information (CSI) processing component 140 configured to receive, from a network entity, a channel state information-reference signal (CSI-RS) associated with a first CSI report; and transmit, to the network entity, a CSI report transmission with at least a first portion of the first CSI report being omitted from the CSI report transmission when a total payload size of the CSI report transmission exceeds a threshold.

In certain aspects, any of the base stations 104 or a network entity of the base stations 104 may include a network-based CSI processing component 150 configured to transmit, to a UE, a CSI-RS associated with a first CSI report; and receive, from the UE, a CSI report transmission with at least a first portion of the first CSI report being omitted from the CSI report transmission based on a total payload size of the CSI report transmission exceeding a threshold.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

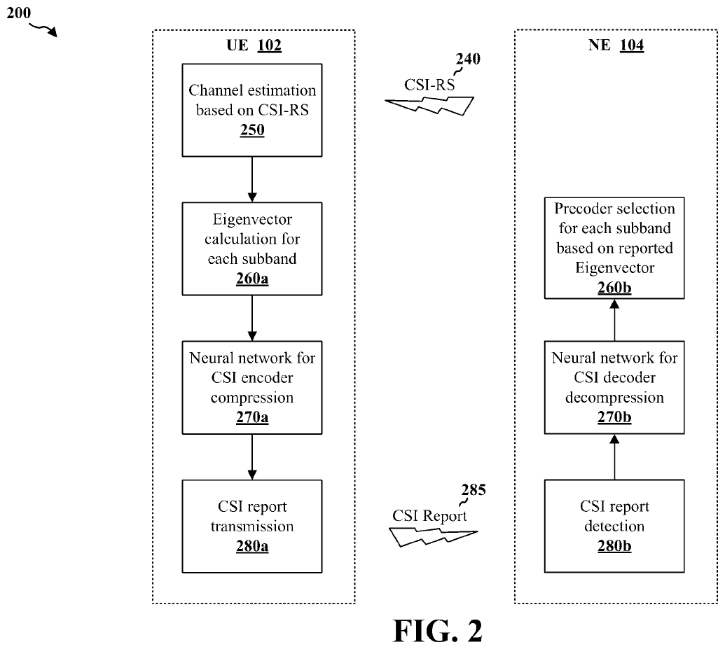

FIG. 2 illustrates a diagram 200 for example machine learning (ML)-based CSI encoder compression at a UE 102 and example ML-based CSI decoder decompression at a network entity 104. In a MIMO system, the network entity 104 may use CSI to select a digital precoder for a UE 102. The network entity 104 may configure a CSI report 285 through RRC signaling (e.g., CSI-reportConfig), where the UE 102 uses a channel measurement resource (CMR) to measure a CSI-RS 240 for estimating 250 a downlink channel. The network entity 104 may also configure (e.g., via the CSI-reportConfig), an interference measurement resource (IMR) for the UE 102 to measure interference. Based on the CMR and the IMR, the UE 102 is able to identify the CSI, which may include a rank indicator (RI), a precoding matrix indicator (PMI), a channel quality indicator (CQI), and/or a layer indicator (LI). The RI and the PMI are used to determine a digital precoder (also called a precoding matrix), the CQI indicates a signal-to-interference plus noise (SINR) for determining the transmitter's selection of a modulation and coding scheme (MCS). The LI is used to identify a strongest layer, such as for multi-user (MU)-MIMO pairing with low rank transmissions and the precoder selection for a phase-tracking reference signal (PT-RS).

The UE 102 may indicate the CSI report 285 in two parts via physical uplink control channel (PUCCH)/physical uplink shared channel (PUSCH), where CSI part 1 may include the RI and the CQI for a first transport block (TB), and CSI part 2 may include the PMI, the LI, and the CQI for a second TB. A payload size for CSI part 2 may be based on the CSI part 1, and both parts may be transmitted to the network entity 104 with separate channel coding operations.

The network entity 104 may configure a time-domain behavior (e.g., periodic, semi-persistent, or aperiodic report) for the CSI report 285 in the CSI-reportConfig. The network entity 104 can activate or deactivate a semi-persistent CSI report through a medium access control-control element (MAC-CE). The network entity 104 can also trigger an aperiodic CSI report through downlink control information (DCI). The UE 102 may report the periodic CSI on a PUCCH resource configured in the CSI-reportConfig. The UE 102 may report the semi-persistent CSI on a PUCCH resource configured in the CSI-reportConfig or a PUSCH resource triggered by the DCI from the network entity 104. The UE 102 may report the aperiodic CSI on a PUSCH resource triggered by the DCI from the network entity 104.

In resource element k for a CSI-RS 240, the received signal in frequency domain may be obtained as follows:

$${Y}_{k} = {H}_{k} {X}_{k} + {N}_{k}$$

where Hₖ indicates the effective channel including an analog beamforming weight with a dimension of N_{Rx} by N_{Tx}, Xₖ indicates the CSI-RS 240 at resource element k, Nₖ indicates the interference plus noise, N_{Rx} indicates a number of receiving ports, and N_{Tx} indicates a number of transmission ports.

In resource element k for a physical downlink shared channel (PDSCH), the received signal in frequency domain may correspond to:

$${Y}_{k} = {H}_{k} {W}_{k} {X}_{k} + {N}_{k}$$

where Wₖ indicates the precoder. Usually for subcarriers within a subband (e.g., a bundled physical resource block (PRB)), the precoder is the same.

The UE 102 may use a Type 2 CSI codebook to measure and report the CSI, where the precoder is quantized based on:

$$W = {W}_{1} {W}_{2}$$

where W₁ corresponds to a wideband precoder with dimensions of N_{Tx} by 2L; W₂ corresponds to a subband precoder with dimensions of 2L by v; L corresponds to a number of beams; and y corresponds to a number of layers, which may be RI+1.

W₁ may be quantized based on a codebook, while W₂ may be quantized based on a power and an angle for each element, which may result in a large overhead since W₂ is subband-based, and there may be multiple subbands for the CSI report 285, which may be determined based on a bandwidth for the CSI-RS 240. In examples, the codebook for W₁ selection may correspond to:

$${W}_{1} = [ \begin{matrix}B & 0 \\ 0 & B\end{matrix} ]$$

$$B = [ \begin{matrix}{b}_{1} & {b}_{2} & ... & {b}_{L}\end{matrix} ]$$

$${b}_{l} = {u}_{m} ⊗ {v}_{n}$$

$${u}_{m} = [ \begin{matrix}1 & {e}^{\frac{j 2 π m}{{N}_{1} {O}_{1}}} & … & {{e}^{\frac{j 2 π ( {N}_{1} - 1 ) m}{{N}_{1} {O}_{1}}} ]}^{T}\end{matrix}$$

$${v}_{n} = [ \begin{matrix}1 & {e}^{\frac{j 2 π n}{{N}_{2} {O}_{2}}} & … & {{e}^{\frac{j 2 π ( {N}_{2} - 1 ) n}{{N}_{2} {O}_{2}}} ]}^{T}\end{matrix}$$

where, ⊗ denotes a Kronecker product; L indicates the number of beams configured by RRC signaling; N₁, N₂, O₁, and O₂ correspond to the number of ports and an oversampling factor in a horizontal and vertical domain, which may be configured via the RRC signaling. Candidate values may be based on the number of CSI-RS ports. The codebook includes precoders with different values of m and n. In examples, the candidate values are based on predefined protocols.

ML is an example technique that the UE 102 may implement for performing the CSI compression 270a, where a first v columns of an Eigen vector for an average channel for each subband may be used as input. As used herein, unless otherwise specifically indicated, the terms “machine learning” and “artificial intelligence” may be used interchangeably with each other.

The diagram 200 illustrates an example for ML-based CSI compression after the UE 102 receives the CSI-RS 240 from the network entity 104. The UE 102 may perform channel estimation 250 based on the CSI-RS 240, and calculate 260a the Eigenvector for the channel in each subband. The Eigenvectors may be input to a neural network for CSI encoder compression 270a. The UE 102 transmits 280a the compressed CSI report 285 to the network entity 104.

The network entity 104 performs CSI report detection 280b of the CSI report transmission 280a from the UE 102. A neural network at the network entity 104 decodes the compressed CSI report 285 to recover the Eigenvector via CSI decoder decompression 270b. The network entity 104 selects 260b a precoder for each subband based on the reported Eigenvector.

For each subband, the Eigenvector V may be derived based on singular vector decomposition (SVD) of the average channel in the subband as follows.

$${USV}^{H} = \frac{1}{N} {\sum }_{k ∈ S} {\hat{H}}_{k}$$

where N indicates the number of CSI-RS resource elements for the subband S; Ĥₖ indicates the estimated channel based on the CSI-RS 240 at resource element k.

ML-based CSI compression techniques may refer to the following terminology:

Data collection refers to a process of collecting data by the network nodes, the management entity, or the UE 102 for ML model training, data analytics, and inference.

ML model refers to a data-driven algorithm that applies ML techniques to generate a set of outputs based on a set of inputs.

ML model training refers to a process of training the ML model (e.g., by learning the input/output relationship) in a data-driven manner to obtain the trained ML model for inference.

ML model inference refers to a process of using the trained ML model to generate a set of outputs based on a set of inputs.

ML model validation refers to a sub-process of ML model training for evaluating a quality of the ML model using a dataset different from a training dataset used for model training. The different data may be used for selecting model parameters that generalize the data beyond the dataset used for the ML model training.

ML model testing refers to a sub-process of ML model training for evaluating the performance of the trained ML model using the dataset that is different from the training dataset for the ML model training and validation. Different from ML model validation, testing does not assume subsequent tuning of the ML model.

UE-side ML model refers to an ML model where inferencing is performed at the UE 102.

Network-side ML model refers to an ML model where inferencing is performed at the network/network entity 104.

One-sided ML model refers to a UE-side ML model or a network-side ML model.

Two-sided ML model refers to a paired ML model(s) over which joint inference is performed, where joint inference includes an ML inference that is performed jointly across the UE 102 and the network entity 104 (e.g., a first portion of inference is performed by the UE 102 and a remaining portion of the inference is performed by the network entity 104, or vice versa).

ML model transfer refers to delivery of an ML model over an air interface, based on either parameters of a model structure known at the receiving end or a new model with parameters. Delivery techniques may include transfer of a full ML model or a ML partial model.

Model download refers to ML model transfer from the network entity 104 to the UE 102.

Model upload refers to ML model transfer from the UE 102 to the network entity 104.

Federated learning/federated training refers to a machine learning technique that trains an ML model across multiple decentralized edge nodes (e.g., UEs, network entities, etc.) that each perform local model training using local data samples. Federated learning/training may be based on multiple interactions with the ML model, but without exchanging local data samples.

Offline field data refers to the data collected from the field and used for offline training of the ML model.

Online field data refers to the data collected from the field and used for online training of the ML model.

Model monitoring refers to a procedure for monitoring the inference performance of the ML model.

Supervised learning refers to a process of training a model from inputs and corresponding labels.

Unsupervised learning refers to a process of training a model without labelled data.

Semi-supervised learning refers to a process of training a model based on a mix of labelled data and unlabelled data.

Reinforcement learning (RL) refers to a process of training an ML model from input (a.k.a. state) and a feedback signal (a.k.a. reward) resulting from the model's output (a.k.a. action) in an environment with which the model interacts.

Model activation refers to enabling an ML model for a specific function.

Model deactivation refers to disabling an ML model for a specific function.

Model switching refers to deactivating a currently active ML model and activating a different ML model for a specific function.

The UE 102 may be configured with multiple CSI-reportConfig. In some examples, the configuration may be based on ML techniques (e.g., ML-based CSI reporting). In other examples, the UE 102 may be configured based on codebook techniques (e.g., non-ML-based CSI reporting). The UE 102 may be triggered by the network entity 104 to report CSI based on the multiple CSI-reportConfig by PUSCH or PUCCH. If the total payload size of the CSI report exceeds the maximum payload size for CSI part 2 in the PUSCH/PUCCH, some portions of the CSI report may have to be omitted. For multiple ML-based CSI reports or mixed ML-based/non-ML-based CSI reports, the UE 102 may implement techniques for CSI omission from the multiple ML-based/non-ML-based CSI reports as well as CSI omission from individual ML-based CSI reports.

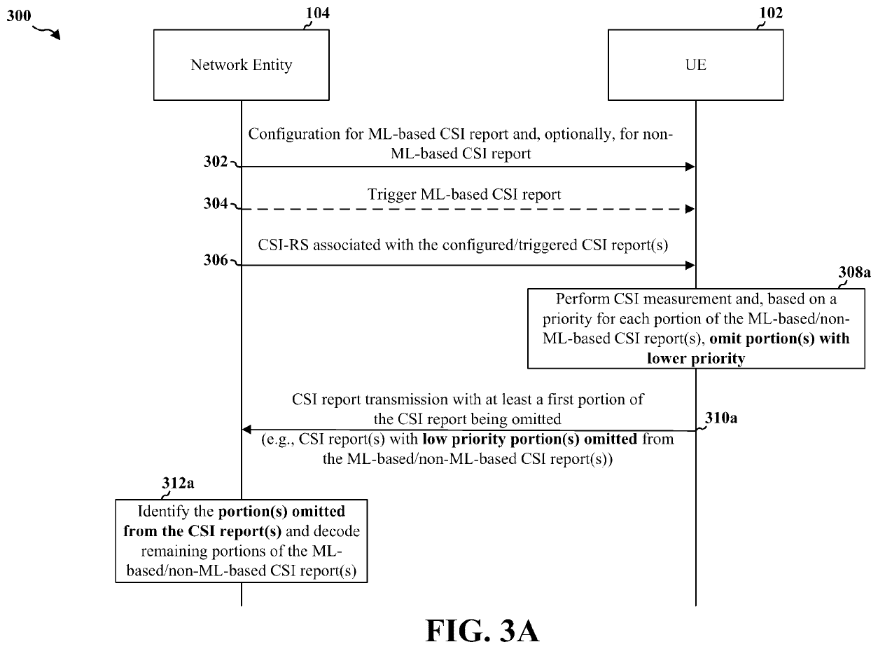

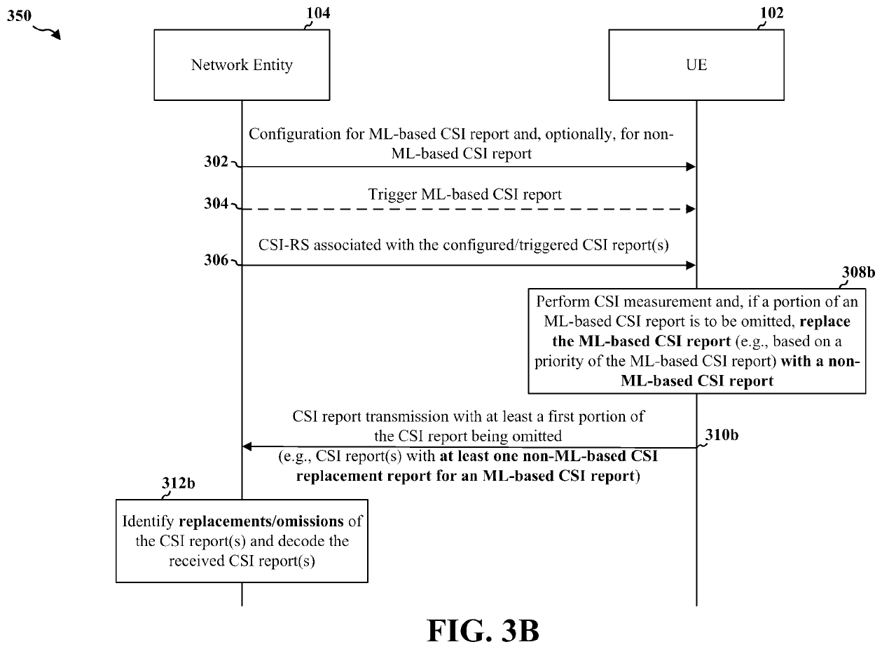

FIG. 3A illustrates a signaling diagram 300 of a first CSI reporting procedure associated with CSI omission techniques. If an overhead for multiple CSI reports exceeds a maximum payload size for a PUSCH/PUCCH for the CSI reports, CSI part 2 may be omitted from the CSI reports based on a priority rule, such that the total payload size for CSI reports is reduced to a size that is less than or equal to the maximum payload size supported for the PUSCH/PUCCH. CSI reports with a higher priority “value” (i.e., lower overall priority) may also be omitted from the reporting procedure. For example, a first CSI report with priority value=1 has a lower priority than a second CSI report with priority value=0, and may be omitted if the total payload size of the CSI reports exceeds the maximum payload size.

A network entity 104 transmits 302 RRC signaling to a UE 102 to configure at least one ML-based CSI report (e.g., CSI-reportConfig). A CSI report may be ML-based when a codebookType in the CSI-reportConfig is set to a first particular value (e.g., ‘ai-Ml’ or ‘type3’) or a reportQuantity in the CSI-reportConfig is set as a second particular value (e.g., ‘ri-compressedPmi-cqi’). The network entity 104 may optionally configure 302 at least one non-ML-based CSI report, which may be based on a particular codebook (e.g., Type1 or Type2 codebook). The configuration can further include information for the UE 102 to omit a portion of, or all of, an ML-based CSI report or a non-ML-based CSI report when the total payload size of a CSI report transmission from the UE 102 exceeds a threshold for the maximum payload size.

The network entity 104 may trigger 304 at least one ML-based CSI report (e.g., by MAC-CE or DCI). In examples, the network entity 104 transmits 304 the MAC-CE to activate semi-persistent CSI report(s). In other examples, the network entity 104 transmits 304 the DCI to trigger aperiodic CSI report(s). The UE 102 may report periodic CSI reports via uplink resources configured 302 by the RRC signaling from the network entity 104.

The UE 102 receives 306, from the network entity 104, CSI-RS(s) associated with the triggered or configured CSI report(s). The UE 102 may perform 308a a CSI measurement of the CSI-RS(s) associated with the triggered or configured CSI reports to determine the CSI for the CSI reports. If the network entity 104 configures 302 or triggers 304 multiple CSI reports with a total payload size that exceeds the maximum payload size for the PUCCH/PUSCH used for the CSI report, the UE 102 may determine to implement a CSI omission procedure to omit 308 CSI reports (as illustrated in FIG. 3B) or portions of the CSI reports (as illustrated in FIG. 3A) from the CSI report transmission 310 to the network entity 104. That is, the UE 102 may transmit 310 to the network entity 104 a CSI report transmission with at least a first portion of the CSI report being omitted. In some implementations, such as illustrated in FIG. 3A, the at least the first portion of the CSI report being omitted can refer to CSI report(s) with low priority portion(s) being omitted from the ML-based/non-ML-based CSI report(s) in the CSI report transmission. In the signaling diagram 300, the UE 102 determines a priority of each portion of the ML-based/non-ML-based CSI reports. If CSI omission techniques are to be implemented for the ML-based/non-ML-based CSI reports, the UE 102 may omit 308a low priority portion(s) of the ML-based/non-ML-based CSI reports from the CSI transmission. In other implementations, such as illustrated in FIG. 3B, the at least the first portion of the CSI report being omitted can refer to an ML-based CSI report being replaced with a non-ML-based CSI report in the CSI report transmission.

To transmit 310 the CSI report transmission with the at least the first portion of the CSI report being omitted, the UE 102 transmits 310a, in the diagram 300, the CSI report(s) with the remaining (i.e., non-omitted) content of the ML-based/non-ML-based CSI report(s) that have been triggered 304 or configured 302 by the network entity 104. That is, the UE 102 transmits 310a CSI report(s) with low priority portion(s) omitted from the ML-based/non-ML-based CSI report(s). The CSI report transmission may include an indication of the omitted portion(s) of the ML-based/non-ML-based CSI report(s). The CSI report(s) may be transmitted 310a on a PUCCH or a PUSCH. For PUCCH transmissions, the CSI reports may be reported using a long PUCCH format. For PUSCH transmissions, the CSI reports may be reported using a short PUCCH format.

The network entity 104 identifies 312a the portion(s) omitted from the CSI report(s) based on the CSI omission procedure/techniques and decode 312a the remaining portions of the ML-based/non-ML-based CSI report(s) received 310a from the UE 102. FIG. 3A illustrates CSI omissions techniques for omitting 308a portion(s) of ML-based/non-ML-based CSI report(s), whereas FIG. 3B illustrates CSI omissions techniques that include replacing a more complex ML-based CSI report with a less complex non-ML-based CSI report in the CSI report transmission.

FIG. 3B illustrates a signaling diagram 350 of a second CSI reporting procedure associated with CSI omission techniques. Elements 302, 304, and 306 have already been described with respect to FIG. 3A.

The UE 102 performs 308b a CSI measurement of the one or more CSI-RS(s) received 306 from the UE 102. The UE 102 can also determine a priority of the ML-based CSI reports and non-ML-based CSI reports. In the signaling diagram 350, if a portion of an ML-based CSI report is to be omitted from the CSI report transmission, the UE 102 may replace 308b the entire ML-based CSI report with a non-ML-based CSI report in the CSI report transmission. The UE 102 can also combine the CSI omission techniques of FIG. 3A and FIG. 3B by omitting portion(s) of other ML-based/non-ML-based CSI reports included in the CSI report transmission and/or by omitting portion(s) of the replacement non-ML-based CSI report to further reduce the payload size of the CSI report transmission.

To transmit 310 the CSI report transmission with the at least the first portion of the CSI report being omitted, the UE 102 transmits 310b, to the network entity 104 in the diagram 350, the CSI report(s) with at least one non-ML-based CSI replacement report for an ML-based CSI report. The UE 102 may also transmit 310b other ML-based/non-ML-based CSI report(s) with lower priority portion(s) omitted from the CSI report transmission and/or transmit 310b the non-ML-based CSI replacement with lower priority portion(s) of the non-ML-based CSI replacement report omitted from the CSI report transmission. The CSI report transmission may include an indication of the omitted/replaced ML-based CSI report as well as an indication of the non-ML-based CSI report that is used as the replacement for the omitted replaced ML-based CSI-report. The non-ML-based CSI replacement report may be transmitted 310b on a PUCCH or a PUSCH. For PUCCH transmissions, the CSI reports may be reported using a long PUCCH format. For PUSCH transmissions, the CSI reports may be reported using a short PUCCH format.

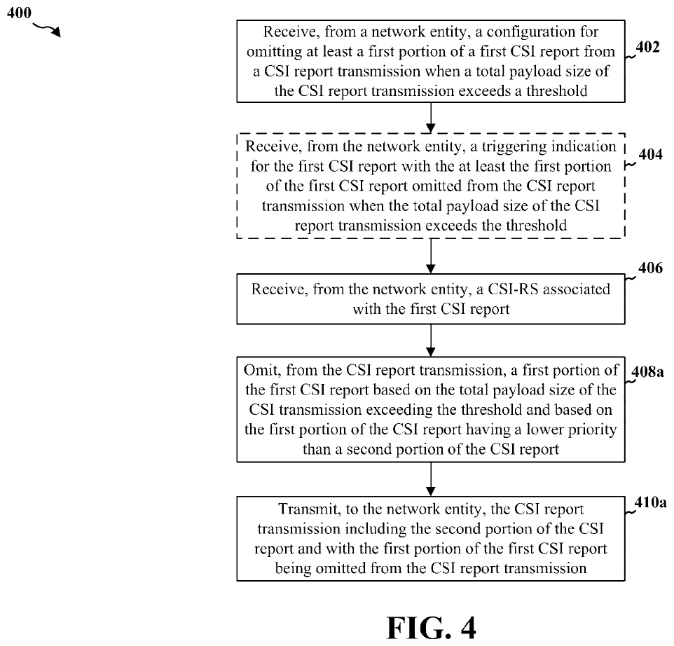

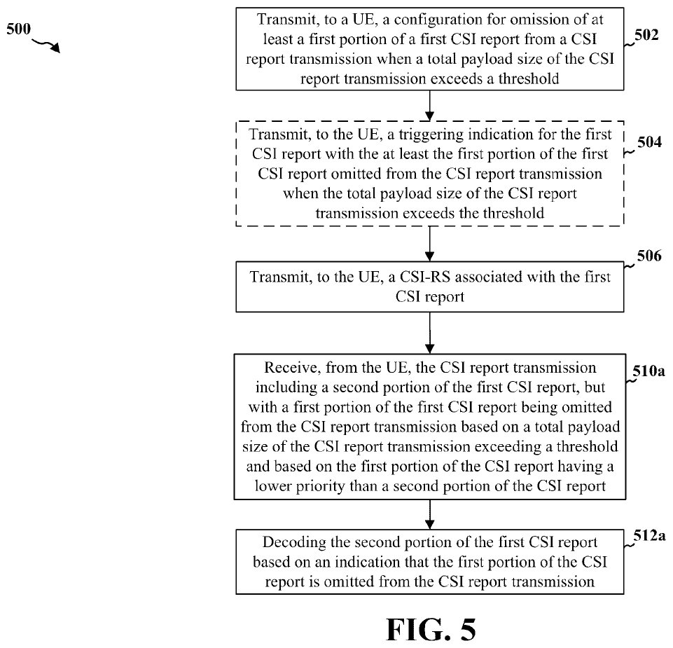

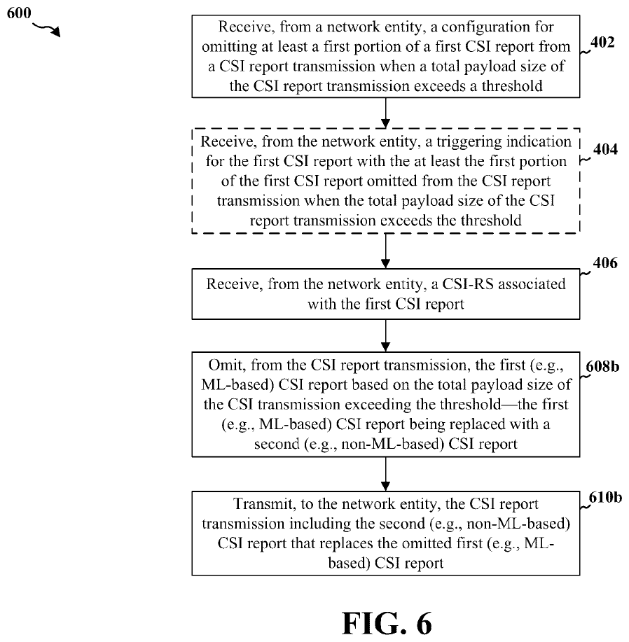

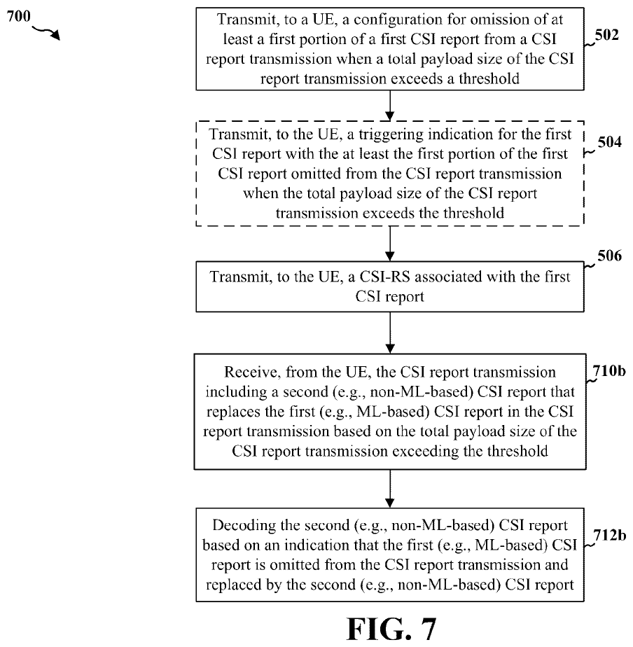

The network entity 104 identifies 312b the replacements/omissions of the CSI report(s) and decodes 312b the received 310b CSI report(s). While the procedure in FIG. 3B can provide more flexibility for the UE 102 to transmit 310 CSI reports in an efficient manner, the procedure in FIG. 3B may also be of higher UE complexity, as the UE 102 potentially measures the CSI-RS(s) based on non-ML-based techniques in addition to ML-based techniques for the CSI report. FIGS. 4-7 show methods for implementing one or more aspects of FIGS. 3A-3B. In particular, FIGS. 4 and 6 shows an implementation by the UE 102 of the one or more aspects of FIGS. 3A-3B. FIGS. 5 and 7 show an implementation by the network entity 104 of the one or more aspects of FIGS. 3A-3B.

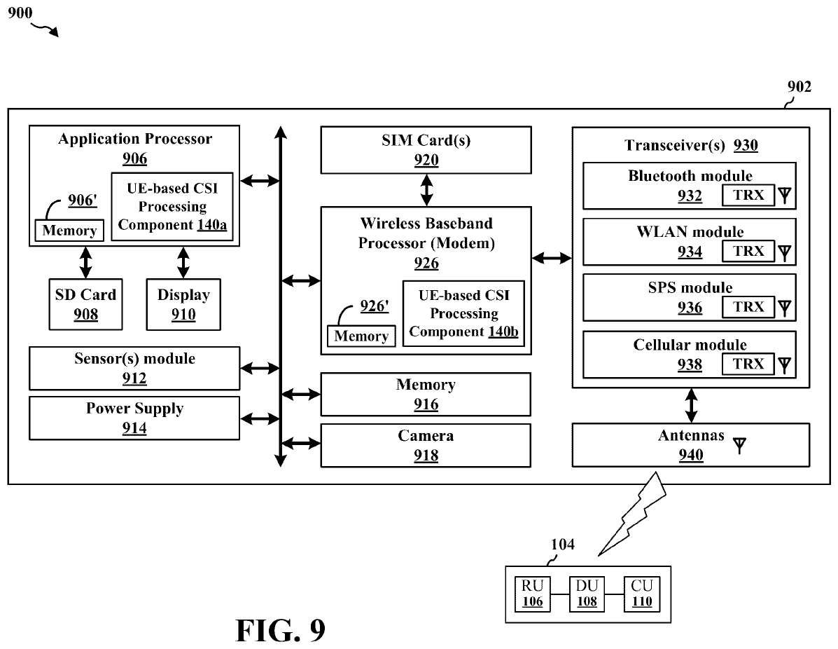

FIG. 4 illustrates a flowchart 400 of a method of wireless communication at a UE for reporting ML-based/non-ML-based CSI reports associated with the CSI omission procedure of FIG. 3A. With reference to FIGS. 3A and 9, the method may be performed by the UE 102, the UE apparatus 902, etc., which may include the memory 926′, 906′, 916, and which may correspond to the entire UE 102 or the entire UE apparatus 902, or a component of the UE 102 or the UE apparatus 902, such as the wireless baseband processor 926 and/or the application processor 906.

The UE 102 receives 402, from a network entity, a configuration for omitting at least a first portion of a first CSI report from a CSI report transmission when a total payload size of the CSI report transmission exceeds a threshold. For example, referring to FIGS. 3A-3B, the UE 102 receives 302, from the network entity 104, a configuration for ML-based CSI reporting and, optionally, for non-ML-based CSI reporting where the UE 102 can omit 308 a portion of, or all of, a CSI report from a transmission to the network entity 104.

The UE 102 receives 404, from the network entity, a triggering indication for the first CSI report with the at least the first portion of the first CSI report omitted from the CSI report transmission when the total payload size of the CSI report transmission exceeds the threshold. For example, referring to FIGS. 3A-3B, the UE 102 receives 304, from the network entity 104, a triggering indication for an ML-based CSI report.

The UE 102 receives 406, from the network entity, a CSI-RS associated with the first CSI report. For example, referring to FIGS. 3A-3B, the UE 102 receives 306, from the network entity 104, one or more CSI-RSs associate with the configured/triggered CSI report(s) for performing 308 CSI measurement of the one or more CSI-RSs.

The UE 102 omits 408a, from the CSI report transmission, a first portion of the first CSI report based on the total payload size of the CSI transmission exceeding the threshold and based on the first portion of the CSI report having a lower priority than a second portion of the CSI report. For example, referring to FIG. 3A, the UE 102 omits 308a, based on a priority of each portion of the ML-based/non-ML-based CSI report(s), portion(s) of the ML-based/non-ML-based CSI report(s) with low priority.

To transmit the CSI report transmission with the at least the first portion of the CSI report being omitted, the UE 102 transmits 410a, to the network entity, the CSI report transmission including the second portion of the CSI report and with the first portion of the first CSI report being omitted from the CSI report transmission. For example, referring to FIG. 3A, the UE 102 transmits 310a, to the network entity 104, CSI report(s) with low priority portion(s) omitted from the ML-based/non-ML-based CSI report(s). FIG. 4 describes a method from a UE-side of a wireless communication link, whereas FIG. 5 describes a method from a network-side of the wireless communication link.

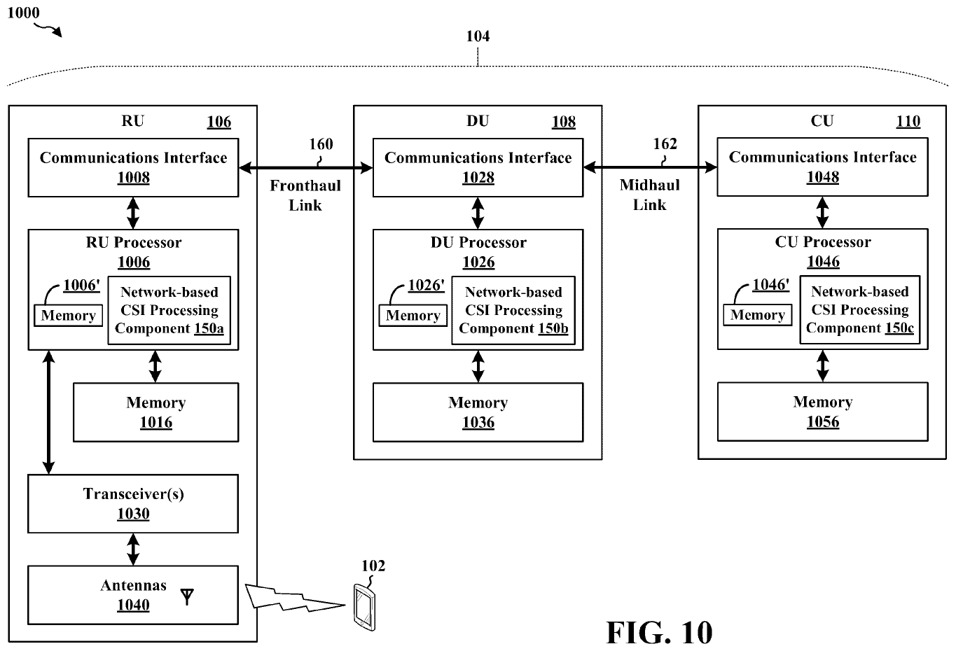

FIG. 5 is a flowchart 500 of a method of wireless communication at a network entity for the ML-based/non-ML-based CSI reports associated with the CSI omission procedure of FIG. 3A. With reference to FIGS. 3A and 10, the method may be performed by one or more network entities 104, which may correspond to a base station or a unit of the base station, such as the RU 106, the DU 108, the CU 110, an RU processor 1006, a DU processor 1026, a CU processor 1046, etc. The one or more network entities 104 may include memory 1006′/1026′/1046′, which may correspond to an entirety of the one or more network entities 104, or a component of the one or more network entities 104, such as the RU processor 1006, the DU processor 1026, or the CU processor 1046.

The network entity 104 transmits 502, to a UE, a configuration for omission of at least a first portion of a first CSI report from a CSI report transmission when a total payload size of the CSI report transmission exceeds a threshold. For example, referring to FIGS. 3A-3B, the network entity 104 transmits 302, to the UE 102, a configuration for ML-based CSI reporting and, optionally, for non-ML-based CSI reporting for having a portion of, or all of, a CSI report omitted from a CSI report reception from the UE 102.

The network entity 104 transmits 504, to the UE, a triggering indication for the first CSI report with the at least the first portion of the first CSI report omitted from the CSI report transmission when the total payload size of the CSI report transmission exceeds the threshold. For example, referring to FIGS. 3A-3B, the network entity 104 transmits 304, to the UE 102, a triggering indication for an ML-based CSI report.

The network entity 104 transmits 506, to the UE, a CSI-RS associated with the first CSI report. For example, referring to FIGS. 3A-3B, the network entity 104 transmits 306, to the UE 102, one or more CSI-RSs associate with the configured/triggered CSI report(s) for receiving CSI feedback from the UE 102.

To receive the CSI report transmission with the at least the first portion of the CSI report being omitted, the network entity 104 receives 510a, from the UE, the CSI report transmission including a second portion of the first CSI report, but with a first portion of the first CSI report being omitted from the CSI report transmission based on a total payload size of the CSI report transmission exceeding a threshold and based on the first portion of the CSI report having a lower priority than a second portion of the CSI report. For example, referring to FIG. 3A, the network entity 104 receives 310a, from the UE 102, CSI report(s) with low priority portion(s) omitted from the ML-based/non-ML-based CSI report(s).

The network entity 104 decodes 512a the second portion of the first CSI report based on an indication that the first portion of the CSI report is omitted from the CSI report transmission. For example, referring to FIG. 3A, the network entity 104 identifies 312a the portion(s) omitted from the CSI report(s) and decodes 312a remaining portions of the ML-based/non-ML-based CSI report(s).

FIG. 6 illustrates a flowchart 600 of a method of wireless communication at a UE for reporting ML-based/non-ML-based CSI reports associated with the CSI omission procedure of FIG. 3B. With reference to FIGS. 3B and 9, the method may be performed by the UE 102, the UE apparatus 902, etc., which may include the memory 926′, 906′, 916, and which may correspond to the entire UE 102 or the entire UE apparatus 902, or a component of the UE 102 or the UE apparatus 902, such as the wireless baseband processor 926 and/or the application processor 906.

Elements 402, 404, and 406 have already been described with respect to FIG. 4.

The UE 102 omits 608b, from the CSI report transmission, the first (e.g., ML-based) CSI report based on the total payload size of the CSI transmission exceeding the threshold—the first (e.g., ML-based) CSI report being replaced with a second (e.g., non-ML-based) CSI report. For example, referring to FIG. 3B, the UE 102 performs 308b CSI measurement of the CSI-RS(s) and, if a portion of an ML-based CSI report is to be omitted the CSI report transmission, the UE 102 replaces 308b the ML-based CSI report in the CSI report transmission (e.g., based on a priority of the ML-based CSI report) with a non-ML-based CSI report.

To transmit the CSI report transmission with the at least the first portion of the CSI report being omitted, the UE 102 transmits 610b, to the network entity, the CSI report transmission including the second (e.g., non-ML-based) CSI report that replaces the omitted first (e.g., ML-based) CSI report. For example, referring to FIG. 3B, the UE 102 transmits 310b, to the network entity 104, CSI report(s) with at least one non-ML-based CSI replacement report for an ML-based CSI report. FIG. 6 describes a method from a UE-side of a wireless communication link, whereas FIG. 7 describes a method from a network-side of the wireless communication link.

FIG. 7 is a flowchart 700 of a method of wireless communication at a network entity for ML-based/non-ML-based CSI reports associated with the CSI omission procedure of FIG. 3B. With reference to FIGS. 3B and 10, the method may be performed by one or more network entities 104, which may correspond to a base station or a unit of the base station, such as the RU 106, the DU 108, the CU 110, an RU processor 1006, a DU processor 1026, a CU processor 1046, etc. The one or more network entities 104 may include memory 1006′/1026′/1046′, which may correspond to an entirety of the one or more network entities 104, or a component of the one or more network entities 104, such as the RU processor 1006, the DU processor 1026, or the CU processor 1046.

Elements 502, 504, and 506 have already been described with respect to FIG. 5.

To receive the CSI report transmission with the at least the first portion of the CSI report being omitted, the network entity 104 receives 710b, from the UE, the CSI report transmission including a second (e.g., non-ML-based) CSI report that replaces the first (e.g., ML-based) CSI report in the CSI report transmission based on the total payload size of the CSI report transmission exceeding the threshold. For example, referring to FIG. 3B, the network entity 104 receives 310b, from the UE 102, CSI report(s) with at least one non-ML-based CSI replacement report for an ML-based CSI report.

The network entity 104 decodes 712b the second (e.g., non-ML-based) CSI report based on an indication that the first (e.g., ML-based) CSI report is omitted from the CSI report transmission and replaced by the second (e.g., non-ML-based) CSI report. For example, referring to FIG. 3B, the network entity 104 identifies 312b replacements/omissions of the CSI report(s) and decodes 312b the received ML-based/non-ML-based CSI report(s).

RRC signaling may indicate an RRC reconfiguration message from the network entity 104 to the UE 102, or a system information block (SIB), where the SIB may be an existing SIB (e.g., SIB1) or a new SIB transmitted by the network entity 104. In addition, the network entity 104 may obtain a UE capability via UE capability report signaling or from a core network (e.g., an Access and Mobility Management Function (AMF)). Whether the ML-based CSI report (e.g., CSI measured with an ML model-based CSI encoder) and non-ML-based CSI report (e.g., CSI measured based on a Type1/Type2 codebook) can be multiplexed and reported on a PUSCH/PUCCH may be indicated by the UE capability or predefined or configured by higher layer signaling from the network entity 104 (e.g., RRC signaling).

The priority for the ML-based CSI report and the non-ML-based CSI report may be different. The network entity 104 and the UE 102 may determine the priority for a CSI report based on the time domain behavior for the CSI report (e.g., periodic/semi-persistent/aperiodic reporting), a CSI-reportConfigId, a serving cell ID, the report quantity, and whether the CSI-RS is measured based on ML or non-ML techniques.

In examples, the priority may be calculated based on: Pri_{iCSI}(y, k, c, s)=2·N_{cells}·Mₛ·y+N_{cells}·Mₛ·k+Mₛ·c+s, where an actual priority is higher if the priority value is lower (e.g., priority 0 corresponds to a higher priority than priority 1). A value of k=0 may indicate CSI reports that include L1-RSRP or L1-SINR information, a value of k=1 may indicate non-ML-based CSI reports that do not include the L1-RSRP or L1-SINR information, and a value of k=2 may indicate ML-based CSI reports that do not include the L1-RSRP or L1-SINR information. Further, y=0 indicates aperiodic CSI reports transmitted on PUSCH, y=1 indicates semi-persistent CSI reports transmitted on the PUSCH, y=2 indicates semi-persistent CSI reports transmitted on PUCCH, and y=3 indicates periodic CSI reports transmitted on PUCCH. Also, c corresponds to the serving cell index and N_{cells} corresponds to a value of the higher layer parameter maxNrofServingCells. Furthermore, s corresponds to the reportConfigID and Mₛ corresponds to a value of the higher layer parameter maxNrofCSI-ReportConfigurations. Alternatively, k=0 may indicate CSI reports carrying L1-RSRP or L1-SINR and k=1 may indicate ML-based CSI reports not carrying L1-RSRP or L1-SINR, k=2 may indicate non-ML-based CSI reports not carrying L1-RSRP or L1-SINR. In another implementation, an ML-based CSI report may be assumed by the network entity 104 and the UE 102 to be with a higher or lower priority compared to a non-ML-based CSI report.

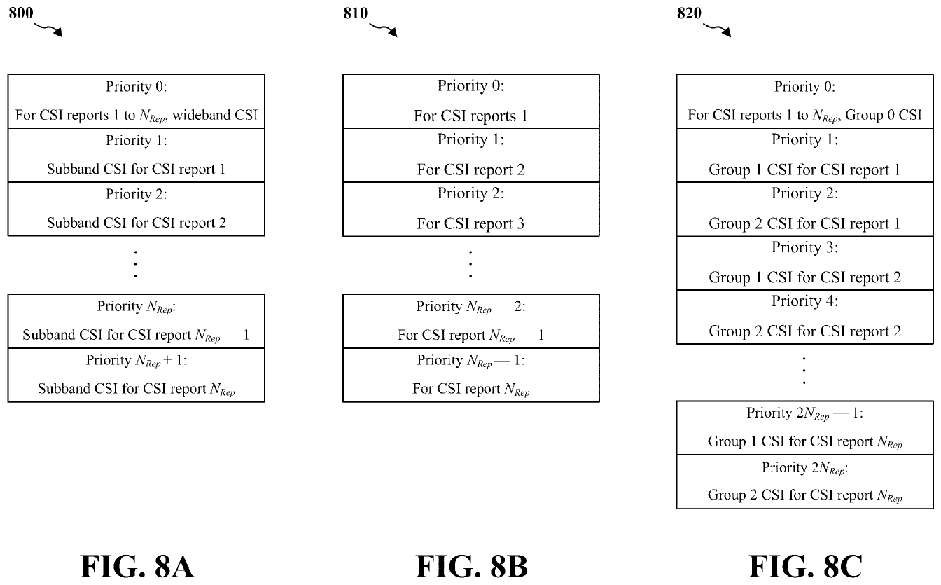

FIGS. 8A-8C illustrate tables 800-820 for ML-based CSI reports. CSI omission procedures may be associated with techniques where ML-based CSI reports include: (1) a first PMI for the ML-based CSI report that indicates the compressed eigen vectors for the channel in all subbands; (2) a first PMI that indicates a selected wideband precoder and a second PMI that indicates the compressed eigen vectors for the precoded channel with the selected wideband precoder in all subbands; or (3) a first PMI that indicates a selected wideband precoder, a second PMI that indicates the compressed eigen vectors for the precoded channel with the selected wideband precoder in even subbands, and a third PMI that indicates the compressed eigen vectors for the precoded channel with the selected wideband precoder in odd subbands.

Within an ML-based CSI report, the wideband PMI and subband PMI may be assumed with different priorities, which may be applicable to options (2) and (3) described above. The priority value of wideband PMI is smaller than subband PMI. That is, when omission is implemented, subband PMI may be omitted. In options (2) and (3), the priority for the first PMI and the second third PMI may be different. The network entity 104 and the UE 102 may determine the priority for N_{Rep} ML-based CSI reports according to the table 800 of FIG. 8A, where CSI report n corresponds to the CSI report with the n′ smallest Pri_{i,CSI}(y,k,c,s) value.

In another embodiment, network entity 104 and the UE 102 assumes a single priority value is assigned to an ML-based CSI report. Such techniques may be applicable for all of options (1), (2), and (3) described above. The CSI omission priority may be determined based on Pri_{i,CSI}(y,k,c,s) according to the table 810 of FIG. 8B.

In another example, the network entity 104 and the UE 102 assume the ML-based CSI reports are divided into 3 priority groups. The priority groups may correspond to: Group 0 for wideband PMI (e.g., the first PMI), Group 1 for subband PMI for even subbands (e.g., the second PMI), and Group 2 for subband PMI for odd subbands (e.g., the third PMI). For an ML-based CSI report, ML-based CSI compression may be performed twice, where the first instance of the compression is for even subbands and the second instance of the compression is for odd subbands.

In another example, the priority groups may correspond to: Group 0 for wideband PMI (e.g., the first PMI), Group 1 for high priority bits for subband PMI (e.g., part of the second PMI), and Group 2 for low priority bits for subband PMI (e.g., other parts of the second PMI). With the high priority bits, the network entity 104 may be able to recover the first Eigen vectors at a certain loss. A high priority for the bits may depend on the ML models and may be predefined or configured by higher layer signaling from the network entity 104 (e.g., RRC signaling in a CSI-reportConfig). The bits in group 1 and group 2 may be generated based on a single ML model or separate ML models.

In another implementation, the priority groups may correspond to: Group 0 being for high priority bits for the PMI in CSI part 2, Group 1 being for medium priority bits for the PMI in CSI part 2, and Group 2 being for low priority bits for the PMI in CSI part 2. Based on the bits having different priorities, the network entity 104 may be able to recover the first Eigen vectors at a certain loss. The bits being of high/medium/low priority may depend on a neural network architecture and may be predefined or configured by higher layer signaling from the network entity 104 (e.g., RRC signaling in a CSI-reportConfig). The bits in groups 1/2/3 may be generated based on a single ML model or separate ML models. Accordingly, the CSI omission priority may be defined according to the table 820 of FIG. 8C.

In an example, if a portion of the ML-based CSI report is to be omitted, the UE 102 may fallback to reporting a non-ML-based CSI report based on a fallback codebook (e.g., Type2 CSI codebook or eType2 CSI codebook). The fallback codebook may be configured by RRC signaling (e.g., RRC parameter in CSI-reportConfig) or predefined or reported by UE capability signaling. The UE 102 can perform CSI omission based on predefined protocols associated with non-ML-based CSI reporting.

In some examples, the network entity 104 may implement the same CSI omission procedure to determine whether the UE reports an ML-based CSI report or a non-ML-based CSI report that replaces the ML-based CSI report. In other implementations, for a CSI report, the UE 102 may report an additional indicator to report whether the CSI is measured based on ML or non-ML techniques. In examples, such indicators may be explicitly transmitted in the CSI report (e.g., an indicator to report the codebook type used for the CSI report). In other examples, the network entity 104 may configure or trigger two PUCCH/PUSCH resources for the CSI report, where a first resource is used for ML-based CSI reports and a second resource is used for non-ML-based CSI reports. By selecting corresponding PUCCH/PUSCH resources, the UE 102 can implicitly report whether the CSI is based on ML or non-ML techniques. In another example, such indicators may be implicitly reported based on a scrambling sequence for demodulation reference signal (DMRS) or PUCCH/PUSCH, where a first scrambling sequence is used to indicate ML-based CSI reports and a second scrambling sequence is used to indicate non-ML-based CSI reports. By receiving such indicators, the network entity 104 may determine whether to decode the CSI as an ML-based CSI report or a non-ML-based CSI report.

The UE 102 may use multiple ML models with different compression ratios for CSI compression, where the ML models may be configured by RRC signaling or predefined. Similarly, the network entity 104 may use multiple ML models with different compression ratios for CSI decompression. The UE 102 may select the ML models with the highest compression ratio that satisfies an overhead limitation for the PUCCH/PUSCH used for the CSI report. The network entity 104 may apply the same CSI omission procedure to determine the ML model for CSI decompression, where the ML model with the highest compression ratio that satisfies the overhead limitation for the PUCCH/PUSCH used for the CSI report is selected.

The UE 102 may report an additional indicator to report an ML model index. The network entity 104 and the UE 102 maintain a list of ML models with different compression ratios. Such ML models may be configured by RRC signaling from the network entity 104 to the UE 102, or reported by the UE capability, or predefined. The indicators may be explicitly transmitted in the CSI report (e.g., an indicator to report the ML model index explicitly). The network entity 104 may configure or trigger X PUCCH/PUSCH resources for the CSI report, where each resource is used for one ML model. By selecting corresponding PUCCH/PUSCH resources, the UE 102 can implicitly report the ML model index. In another example, the indicator may be implicitly reported based on the scrambling sequence for the DMRS or PUCCH/PUSCH, where each scrambling sequence corresponds to an ML model. By receiving such indicators, the network entity 104 may determine the ML model for CSI decompression.

For N_{Rep,1} ML-based CSI reports and N_{Rep,2} non-ML-based CSI reports, the ML-based CSI reports may be assumed by the network entity 104 and the UE 102 to have a higher or lower priority value compared to non-ML-based CSI reports. The UE 102 may determine to omit ML-based or non-ML-based CSI reports in different implementations and, if further omission is to be implemented, the UE 102 may apply CSI omission for the remaining non-ML-based or ML-based CSI reports. The above examples may be implemented for ML-based CSI omission, and predefined protocols may be implemented for non-ML-based CSI omission. For N_{Rep,1} ML-based CSI reports and N_{Rep,2} non-ML-based CSI reports, the network entity 104 and the UE 102 may determine the priority for a CSI report based on the priority for the CSI-reportConfig. The priority within a CSI-reportConfig may be determined based on the priority group.

FIG. 9 is a diagram 900 illustrating an example of a hardware implementation for a UE apparatus 902. The UE apparatus 902 may be the UE 102, a component of the UE 102, or may implement UE functionality. The UE apparatus 902 may include an application processor 906, which may have on-chip memory 906′. In examples, the application processor 906 may be coupled to a secure digital (SD) card 908 and/or a display 910. The application processor 906 may also be coupled to a sensor(s) module 912, a power supply 914, an additional module of memory 916, a camera 918, and/or other related components. For example, the sensor(s) module 912 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 902 may further include a wireless baseband processor 926, which may be referred to as a modem. The wireless baseband processor 926 may have on-chip memory 926′. Along with, and similar to, the application processor 906, the wireless baseband processor 926 may also be coupled to the sensor(s) module 912, the power supply 914, the additional module of memory 916, the camera 918, and/or other related components. The wireless baseband processor 926 may be additionally coupled to one or more subscriber identity module (SIM) card(s) 920 and/or one or more transceivers 930 (e.g., wireless RF transceivers).

Within the one or more transceivers 930, the UE apparatus 902 may include a Bluetooth module 932, a WLAN module 934, an SPS module 936 (e.g., GNSS module), and/or a cellular module 938. The Bluetooth module 932, the WLAN module 934, the SPS module 936, and the cellular module 938 may each include an on-chip transceiver (TRX), or in some cases, just a transmitter (TX) or just a receiver (RX). The Bluetooth module 932, the WLAN module 934, the SPS module 936, and the cellular module 938 may each include dedicated antennas and/or utilize antennas 940 for communication with one or more other nodes. For example, the UE apparatus 902 can communicate through the transceiver(s) 930 via the antennas 940 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 926 and the application processor 906 may each include a computer-readable medium/memory 926′, 906′, respectively. The additional module of memory 916 may also be considered a computer-readable medium/memory. Each computer-readable medium/memory 926′, 906′, 916 may be non-transitory. The wireless baseband processor 926 and the application processor 906 may each be responsible for general processing, including execution of software stored on the computer-readable medium/memory 926′, 906′, 916. The software, when executed by the wireless baseband processor 926/application processor 906, causes the wireless baseband processor 926/application processor 906 to perform the various functions described herein. The computer-readable medium/memory may also be used for storing data that is manipulated by the wireless baseband processor 926/application processor 906 when executing the software. The wireless baseband processor 926/application processor 906 may be a component of the UE 102. The UE apparatus 902 may be a processor chip (e.g., modem and/or application) and include just the wireless baseband processor 926 and/or the application processor 906. In other examples, the UE apparatus 902 may be the entire UE 102 and include the additional modules of the apparatus 902.

As discussed in FIG. 1 and implemented with respect to FIGS. 4 and 6, the UE-based CSI processing component 140 is configured to receive, from a network entity, a CSI-RS associated with a first CSI report; and transmit, to the network entity, a CSI report transmission with at least a first portion of the first CSI report being omitted from the CSI report transmission when a total payload size of the CSI report transmission exceeds a threshold. The UE-based CSI processing component 140 may be within the application processor 906 (e.g., at 140a), the wireless baseband processor 926 (e.g., at 140b), or both the application processor 906 and the wireless baseband processor 926. The UE-based CSI processing component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 10 is a diagram 1000 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1046, which may have on-chip memory 1046′. In some aspects, the CU 110 may further include an additional module of memory 1056 and/or a communications interface 1048, both of which may be coupled to the CU processor 1046. The CU 110 can communicate with the DU 108 through a midhaul link 162, such as an F1 interface between the communications interface 1048 of the CU 110 and a communications interface 1028 of the DU 108.

The DU 108 may include a DU processor 1026, which may have on-chip memory 1026′. In some aspects, the DU 108 may further include an additional module of memory 1036 and/or the communications interface 1028, both of which may be coupled to the DU processor 1026. The DU 108 can communicate with the RU 106 through a fronthaul link 160 between the communications interface 1028 of the DU 108 and a communications interface 1008 of the RU 106.

The RU 106 may include an RU processor 1006, which may have on-chip memory 1006′. In some aspects, the RU 106 may further include an additional module of memory 1016, the communications interface 1008, and one or more transceivers 1030, all of which may be coupled to the RU processor 1006. The RU 106 may further include antennas 1040, which may be coupled to the one or more transceivers 1030, such that the RU 106 can communicate through the one or more transceivers 1030 via the antennas 1040 with the UE 102.

The on-chip memory 1006′, 1026′, 1046′ and the additional modules of memory 1016, 1036, 1056 may each be considered a computer-readable medium/memory. Each computer-readable medium/memory may be non-transitory. Each of the processors 1006, 1026, 1046 is responsible for general processing, including execution of software stored on the computer-readable medium/memory. The software, when executed by the corresponding processor(s) 1006, 1026, 1046 causes the processor(s) 1006, 1026, 1046 to perform the various functions described herein. The computer-readable medium/memory may also be used for storing data that is manipulated by the processor(s) 1006, 1026, 1046 when executing the software. In examples, the network-based CSI processing component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIGS. 5 and 7, the network-based CSI processing component 150 is configured to transmit, to a UE, a CSI-RS associated with a first CSI report; and receive, from the UE, a CSI report transmission with at least a first portion of the first CSI report being omitted from the CSI report transmission based on a total payload size of the CSI report transmission exceeding a threshold. The network-based CSI processing component 150 may be within one or more processors of the one or more network entities 104, such as the RU processor 1006 (e.g., at 150a), the DU processor 1026 (e.g., at 150b), and/or the CU processor 1046 (e.g., at 150c). The network-based CSI processing component 150a-150c may be one or more hardware components specifically configured to carry out the stated processes/algorithm, implemented by one or more processors 1006, 1026, 1046 configured to perform the stated processes/algorithm, stored within a computer-readable medium for implementation by the one or more processors 1006, 1026, 1046, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a CSI-RS associated with a first CSI report; and transmitting, to the network entity, a CSI report transmission with at least a first portion of the first CSI report being omitted from the CSI report transmission when a total payload size of the CSI report transmission exceeds a threshold.

Example 2 may be combined with Example 1 and includes that the CSI report transmission includes a plurality of CSI reports, the plurality of CSI reports including at least one of: an ML-based CSI report or a non-ML-based CSI report.

Example 3 may be combined with any of Examples 1-2 and includes that the at least the first portion of the first CSI report being omitted from the CSI report transmission is based on the at least the first portion of the first CSI report having a lower priority than a second portion of the first CSI report.

Example 4 may be combined with Example 3 and includes that the first CSI report is the ML-based CSI report.

Example 5 may be combined with Example 3 and includes that the first CSI report is the non-ML-based CSI report.

Example 6 may be combined with any of Examples 1-2 and includes that the first CSI report is the ML-based CSI report, and includes that the at least the first portion of the first CSI report being omitted from the CSI report transmission, further includes: replacing the first CSI report in the CSI report transmission with a second CSI report, the second CSI report being the non-ML-based CSI report.

Example 7 may be combined with Example 6 and includes that the replacing the first CSI report with the second CSI report is based on the first CSI report having a priority level that is lower than a threshold priority level.

Example 8 may be combined with any of Examples 6-7 and includes that the CSI report transmission is of the plurality of CSI reports and includes the second CSI report and a third CSI report, the transmitting the CSI report transmission being based on part of the third CSI report being omitted from the CSI report transmission.

Example 9 may be combined with any of Examples 1-8 and includes that the CSI report transmission includes an indication that the at least the first portion of the first CSI report is omitted from the CSI report transmission.

Example 10 may be combined with any of Examples 1-9 and further includes receiving, from the network entity, a configuration for omitting the at least the first portion of the first CSI report from the CSI report transmission when the total payload size of the CSI report transmission exceeds the threshold.

Example 11 may be combined with any of Examples 1-10 and further includes receiving, from the network entity, a triggering indication for the first CSI report with the at least the first portion of the first CSI report omitted from the CSI report transmission when the total payload size of the CSI report transmission exceeds the threshold.

Example 12 is a method of wireless communication at a network entity, including: transmitting, to a UE, a CSI-RS associated with a first CSI report; and receiving, from the UE, a CSI report transmission with at least a first portion of the first CSI report being omitted from the CSI report transmission based on a total payload size of the CSI report transmission exceeding a threshold.

Example 13 may be combined with Example 12 and includes that the CSI report transmission includes a plurality of CSI reports, the plurality of CSI reports including at least one of: an ML-based CSI report or a non-ML-based CSI report.

Example 14 may be combined with any of Examples 12-13 and includes that the at least the first portion of the first CSI report being omitted from the CSI report transmission is based on the at least the first portion of the first CSI report having a lower priority than a second portion of the first CSI report.

Example 15 may be combined with Example 14 and includes that the first CSI report is the ML-based CSI report.

Example 16 may be combined with Example 14 and includes that the first CSI report is the non-ML-based CSI report.

Example 17 may be combined with any of Examples 12-13 and includes that the first CSI report is the ML-based CSI report, and includes that the at least the first portion of the first CSI report being omitted from the CSI report transmission includes the first CSI report being replaced with a second CSI report, the second CSI report being the non-ML-based CSI report.

Example 18 may be combined with Example 17 and includes that the first CSI report being replaced with the second CSI report is based on the first CSI report having a priority level that is lower than a threshold priority level.

Example 19 may be combined with any of Examples 17-18 and includes that the CSI report transmission is of the plurality of CSI reports and includes the second CSI report and a third CSI report, and includes that the receiving the CSI report transmission includes part of the third CSI report being omitted from the CSI report transmission.

Example 20 may be combined with any of Examples 12-19 and includes that the CSI report transmission includes an indication that the at least the first portion of the first CSI report is omitted from the CSI report transmission.

Example 21 may be combined with any of Examples 12-20 and further includes transmitting, to the UE, a configuration for omission of the at least the first portion of the first CSI report from the CSI report transmission when the total payload size of the CSI report transmission exceeds the threshold.

Example 22 may be combined with any of Examples 12-21 and further includes transmitting, to the UE, a triggering indication for the first CSI report with the at least the first portion of the first CSI report being omitted from the CSI report transmission when the total payload size of the CSI report transmission exceeds the threshold.

Example 23 may be combined with any of Examples 12-22 and further includes decoding the CSI report transmission based on an indication that the at least the first portion of the first CSI report is omitted from the CSI report transmission

Example 24 is an apparatus for wireless communication for implementing a method as in any of Examples 1-23.

Example 25 is an apparatus for wireless communication including means for implementing a method as in any of Examples 1-23.

Example 26 is a non-transitory computer-readable medium storing computer executable code, the code when executed by at least one processor causes the at least one processor to implement a method as in any of Examples 1-23.

1.-16. (canceled)

17. A method of wireless communication at a user equipment (UE), comprising:
receiving, from a network entity, a channel state information-reference signal (CSI-RS) associated with a first channel state information (CSI) report, the first CSI report including a machine learning (ML)-based CSI report; and
transmitting, to the network entity, a CSI report transmission with at least a first portion of the first CSI report being omitted from the CSI report transmission when a total payload size of the CSI report transmission exceeds a threshold.

18. The method of claim 17, wherein the CSI report transmission includes a plurality of CSI reports, the plurality of CSI reports including at least one of: the first CSI report or a non-ML-based CSI report.

19. The method of claim 17, wherein the at least the first portion of the first CSI report being omitted from the CSI report transmission is based on the at least the first portion of the first CSI report having a lower priority than a second portion of the first CSI report.

20. The method of claim 17, further comprising:
replacing the at least the first portion of the first CSI report in the CSI report transmission with a second CSI report, the second CSI report including a non-ML-based CSI report.

21. The method of claim 20, wherein the replacing the at least the first portion of the first CSI report with the second CSI report is based on the first CSI report having a priority level that is lower than a threshold priority level.

22. The method of claim 20, wherein the CSI report transmission includes a second CSI report and a third CSI report, wherein the transmitting the CSI report transmission is based on a portion of the third CSI report being omitted from the CSI report transmission.

23. The method of claim 17, wherein the CSI report transmission includes an indication that the at least the first portion of the first CSI report is omitted from the CSI report transmission.

24. The method of claim 17, further comprising:
receiving, from the network entity, a configuration for omitting the at least the first portion of the first CSI report from the CSI report transmission when the total payload size of the CSI report transmission exceeds the threshold.

25. The method of claim 17, further comprising:
receiving, from the network entity, a triggering indication for the first CSI report with the at least the first portion of the first CSI report omitted from the CSI report transmission when the total payload size of the CSI report transmission exceeds the threshold.

26. A method of wireless communication at a network entity, comprising:
transmitting, to a user equipment (UE), a channel state information-reference signal (CSI-RS) associated with a first channel state information (CSI) report, the first CSI report including a machine learning (ML)-based CSI report; and
receiving, from the UE, a CSI report transmission with at least a first portion of the first CSI report being omitted from the CSI report transmission based on a total payload size of the CSI report transmission exceeding a threshold.

27. The method of claim 26, wherein the CSI report transmission includes a plurality of CSI reports, the plurality of CSI reports including at least one of: the first CSI report or a non-ML-based CSI report.

28. The method of claim 26, wherein the at least the first portion of the first CSI report being omitted from the CSI report transmission is based on the at least the first portion of the first CSI report having a lower priority than a second portion of the first CSI report.

29. The method of claim 26, wherein the at least the first portion of the first CSI report omitted from the CSI report transmission is replaced with a second CSI report, the second CSI report including a non-ML-based CSI report.

30. The method of claim 26, further comprising:
decoding the CSI report transmission based on an indication that the at least the first portion of the first CSI report is omitted from the CSI report transmission.

31. An apparatus for wireless communication at a user equipment (UE), comprising:
a memory;
a transceiver; and
a processor coupled to the memory and the transceiver, the processor being configured to:
receive, from a network entity, a channel state information-reference signal (CSI-RS) associated with a first channel state information (CSI) report, the first CSI report including a machine learning (ML)-based CSI report; and
transmit, to the network entity, a CSI report transmission with at least a first portion of the first CSI report being omitted from the CSI report transmission when a total payload size of the CSI report transmission exceeds a threshold.

32. The apparatus of claim 31, wherein the CSI report transmission includes a plurality of CSI reports, the plurality of CSI reports including at least one of: the first CSI report or a non-ML-based CSI report.

33. The apparatus of claim 31, wherein the at least the first portion of the first CSI report being omitted from the CSI report transmission is based on the at least the first portion of the first CSI report having a lower priority than a second portion of the first CSI report.

34. The apparatus of claim 31, wherein the processor is further configured to:
replace the at least the first portion of the first CSI report in the CSI report transmission with a second CSI report, the second CSI report including a non-ML-based CSI report.

35. The apparatus of claim 18, wherein the first CSI report has a priority level that is lower than a threshold priority level.

36. The apparatus of claim 31, wherein the CSI report transmission includes an indication that the at least the first portion of the first CSI report is omitted from the CSI report transmission.
